(19) United States
(12) Patent Application Publication
(10) Pub. No.: US 2025/0193001 A1
(43) Pub. Date: Jun. 12, 2025

(54) INTEGRATION OF WEB3 OPERATIONS WITH ENTERPRISE WORKFLOWS

(71) Applicant: SAP SE, Walldorf (DE)

(72) Inventor: Narek ASADORIAN, Los Angeles, CA (US)

(21) Appl. No.: 18/535,424

(22) Filed: Dec. 11, 2023

(51) Int. Cl. H04L 9/08

(52) U.S. Cl. CPC H04L 9/088

(57) ABSTRACT

Systems include reception of credentials of a user at a Web server, generation of a token comprising an identifier of the user, reception of a request from the user to transmit a operation to a Web3 database, the request including the token, and, in response to the received request, querying of a database for a identifier associated with the user, requesting of encryption of the operation by a private key associated with the identifier, reception of an encrypted operation in response to the requested encryption of the operation, and transmission of the encrypted operation to the Web3 database.

### BACKGROUND

Modern enterprises use computer-based systems for a multitude of tasks. For example, comprehensive enterprise resource planning systems may be used by most functional units of an enterprise, including but not limited to manufacturing and logistics, customer resource management, supply chain management, human resource management, and finance.

Blockchain-based Web3 technology is increasingly used to provide transactions such as payment processing, contract execution and the like. Since such transactions are typically integral to an enterprise's operations, it may be desirable to use this technology to perform these transactions. However, a typical user does not possess the knowledge needed to successfully and securely generate suitable blockchain transactions and store those transactions on a blockchain.

It is therefore desirable to integrate Web3 technology into existing enterprise workflows in a manner which is relatively transparent to users. This integration is difficult due in part to the differences in protocols used by enterprise systems and blockchain components and to the management of cryptographic keys required by the protocols. Systems are therefore desired to facilitate generation and storage of encrypted blockchain transactions within a typical enterprise usage paradigm.

### BRIEF DESCRIPTION OF THE DRAWINGS

FIG. 1 is a block diagram of a system to submit signed transactions to a blockchain according to some embodiments.

FIG. 2 is a flow diagram of a process to create a custodial wallet according to some embodiments.

FIG. 3 is a flow diagram of a process to transmit signed transactions associated with a custodial wallet to a blockchain according to some embodiments.

FIG. 4 is a user interface for submitting Web authentication credentials according to some embodiments.

FIG. 5 is a user interface for transmitting a transaction to a blockchain according to some embodiments.

FIG. 6 is a detailed block diagram of a system to transmit signed transactions to a blockchain according to some embodiments.

FIG. 7 is code of a remote signing utility according to some embodiments.

FIG. 8 is a block diagram of a system according to some embodiments.

### DETAILED DESCRIPTION

The following description is provided to enable any person in the art to make and use the described embodiments. Various modifications, however, will be readily-apparent to those in the art.

Embodiments may operate based on browser-based user commands to efficiently sign (i.e., encrypt), remotely and on behalf of the users, Web3 database operations (i.e., blockchain transactions) specifying smart contracts, asset transfers, data, or other blockchain entities. According to some embodiments, a user requests performance of a blockchain-related action via a Web2 application, such as deploying a Non-Fungible Token (NFT) contract or minting tokens on a contract. In response, a Web3 interface server including Remote Procedure Call (RPC) routes providing a set of functionalities (e.g., create wallet, fund wallet, defund wallet, drain wallet, sign transaction) automatically builds a corresponding database operation (i.e., blockchain transaction) and uses Application Programming Interface (API) functions of a cloud-based key vault to request encryption of the transaction on behalf of the user. The encrypted (i.e., signed) transaction is then transmitted to a blockchain RPC node for commitment to the blockchain.

Some embodiments operate to programmatically generate and store cryptographic keypairs on behalf of users without external exposure of the private keys of the keypairs. Neither the Web3 interface server nor the user ever sees the private key of the user. As a result, user wallets cannot be used to transfer funds to other wallets or to sign transactions which the user does not intend to sign.

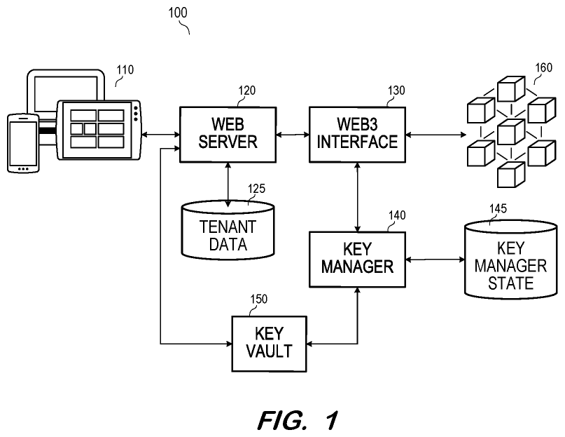

FIG. 1 is a block diagram illustrating system 100 to submit signed operations (i.e., transactions) to a Web3 database such as a blockchain according to some embodiments. Each of the illustrated components may be implemented using any suitable combination of computing hardware and/or software that is or becomes known. In some embodiments, two or more components are implemented by a single computing device. Two or more components of system 100 may be co-located. One or more components may be implemented as a cloud service (e.g., Software-as-a-Service, Platform-as-a-Service). A cloud-based implementation of any components of system 100 may apportion computing resources elastically according to demand, need, price, and/or any other metric.

Each component may comprise, for example, comprise a single computer server, a virtual machine, or a cluster of computer servers such as a Kubernetes cluster. Kubernetes is an open-source system for automating deployment, scaling and management of containerized applications. Each component of system 100 may therefore be implemented by one or more servers (real and/or virtual) or containers. Each data storage component depicted herein may comprise one or more storage systems, each of which may be standalone or distributed, on-premise or cloud-based.

System 100 includes user devices 110 which may be operated by administrators or users of a customer, or tenant. Each of user devices 110 may include a Web browser compatible with Web2 protocols. For example, a Web browser of a user device 110 may request and receive Web pages from Web server 120 and/or execute code of a browser application (which may or may not conform to a user interface framework loaded in the browser) to interact with a corresponding server application executed by Web server 120 to present user interfaces.

An administrator or user may provide authentication credentials (e.g., username and password) to Web server 120 via a user interface presented by a user device 110. Web server 120 executes its server application to perform an authentication process based on the credentials, receive requests from the administrator or user, and provide tenant data 125 in response to the requests and based on data authorizations granted to the administrator or user. The server application may provide any functionality that is or becomes known, including but not limited to the enterprise resource planning functionalities noted above.

User devices 110, Web server 120 and tenant data 125 generally conform to the frontend, backend, and database paradigm of a Web2 architecture. The frontend enables user interaction and requests and receives data from the backend. The backend is a centralized server that receives requests from the frontend, fetches data from the database, and returns the response to the frontend to be displayed. All of the data is stored in the database, which is also a centralized entity.

As illustrated and will be described below, Web server 120 may request generation of a cryptographic keypair (e.g., a public key and a private key) from key vault 150. Key vault 150 generates the keypair, stores the keypair and returns an identifier of the keypair (e.g., a wallet identifier) to Web server 120. The wallet identifier may comprise the public key of the keypair in some embodiments.

The request to generate a keypair may be issued in response to a request received by Web server 120 to create a tenant. A tenant may represent a customer organization, and employees of the organization may be considered users of the tenant. Accordingly, Web server 120 may store the returned identifier of the key pair in association with an identifier of the tenant. In some embodiments, an application executed by Web server 120 may comprise a multi-tenant application, in which case Web server 120 may request generation of a respective keypair for each of several tenants. Web server 120 stores a returned identifier of each generated keypair in association with an identifier of its respective tenant.

Key vault 150 may be operated by an entity different from another one or more entities operating the other components of system 100. Advantageously, these other entities are unable to access the private keys of the keypairs generated by key vault 150. Rather, as will be described below, key vault 150 may only be requested to sign a transaction on behalf of a tenant using its private key and to provide the signed transaction in return.

In Web3 architecture, each block on the blockchain is composed of transactions, but before a transaction can be included in a block, it must be executed by a virtual machine associated with the block chain, such as the Ethereum Virtual Machine (EVM). The EVM runs on top of the blockchain to execute transactions between users and smart contracts and compute the new state resulting from those interactions. The new computed state becomes the base for a new block.

Smart contracts are programs that contain logic written in specifically-purposed languages. The code and variables of a smart contract are deployed and stored on the blockchain. A smart contract deployed to the blockchain is uniquely identified and accessed by its address. An address can identify a smart contract or an externally-owned account. Externally-owned accounts are controlled by users and smart contracts are controlled by code, although both can hold balances and interact with smart contracts.

Web3 interface 130 communicates with Web server 120 to generate a signed transaction for transmission to a blockchain. For example, Web server 120 may generate an RPC call specifying a transaction and transmit the RPC call and a wallet identifier identifying a cryptographic keypair to Web3 interface 130. Web3 interface 130 provides the transaction and the wallet identifier to key manager 140.

Key manager 140 then requests key vault 150 to sign the transaction using the private key associated with the wallet identifier. Key manager state information 145 may associate wallet identifiers with addresses of primary keys within key vault 150 and may therefore be used to facilitate the request to key vault 150. Key vault 150 signs the transaction with a private key associated with the wallet identifier (e.g., using the secp256k1 elliptic curve scheme and the ECDSA signing algorithm), and returns the signed transaction to key manager 140. Web3 interface 130 submits the signed transaction to blockchain 160 by executing a predetermined JSON RPC call which corresponds to the RPC call received from Web server 120. Key manager 140 may transform the transaction prior to providing the transaction to key vault 150 so that the resulting signed transaction received from key vault 150 conforms to a format acceptable to blockchain 160.

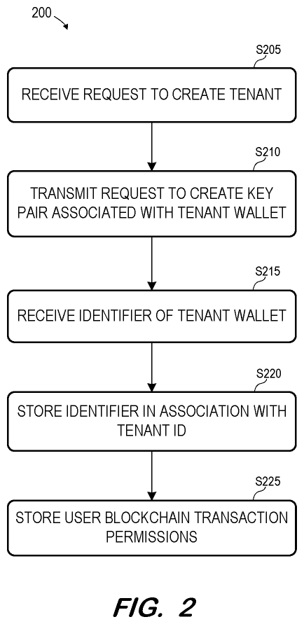

FIG. 2 comprises a flow diagram of process 200 to create a custodial wallet according to some embodiments. Process 200 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape, and executed by any one or more processing units, including but not limited to a microprocessor, a microprocessor core, and a microprocessor thread. Embodiments are not limited to the examples described below.

Initially, at S205, a request is received to create an application tenant. The request may be received, for example, by a Web2 server such as Web server 120 from a Web browser executing on a user device such as user devices 110. According to some examples, an administrator operates a Web browser of a user device to access a Uniform Resource Locator associated with an application executed by Web server 120 and to subsequently interact with the application to request creation of a tenant as is known in the art.

Assuming the administrator is authenticated to the application and authorized to create a tenant, a request is transmitted at S210 to create a keypair associated with a wallet of the tenant. The request may be transmitted to a key vault from which the provider of the application is not permitted and is unable to retrieve private keys. The key vault generates a keypair associated with the wallet and returns an identifier of the wallet at S215. As noted above, the identifier of the wallet may comprise the public key of the keypair.

The wallet identifier is stored in association with an identifier of the new tenant at S220. For example, Web server 120 may store a record including the wallet identifier and the tenant identifier in tenant data 125. According to some embodiments, flow continues to S225 to store blockchain transaction permissions for respective users of the tenant. For example, user identifiers may be stored at S225 in association with data specifying the types of blockchain transactions which the respective users are permitted to perform.

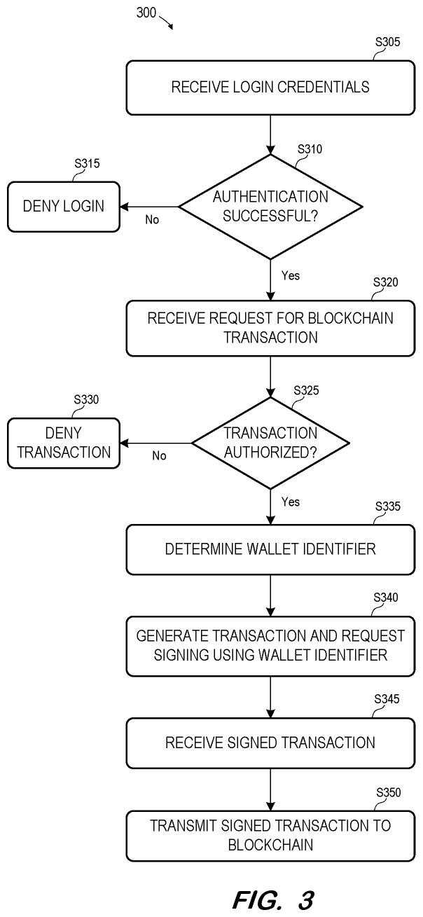

FIG. 3 is a flow diagram of process 300 to transmit transactions associated with a custodial wallet to a blockchain according to some embodiments. Advantageously, the transactions may be created, signed and transmitted in response to user input without requiring the user to be familiar with transaction creation, signing and transmission.

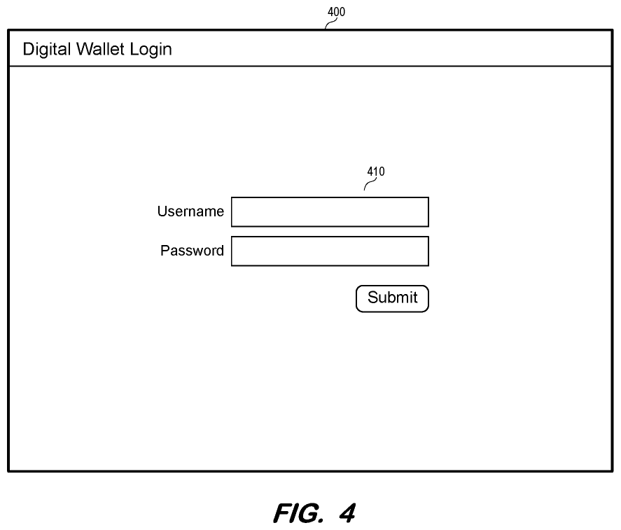

Login credentials are received at S305. For example, a user may operate a Web browser to access a Uniform Resource Locator associated with digital wallet functionality of an application executed by a Web server as is known in the art. FIG. 4 illustrates user interface 400 which may be presented to the user as a result. User interface 400 includes input fields 410 for receiving login credentials (i.e., username and password) of the user at S305.

The credentials are authenticated at S310. Authentication may proceed according to any suitable procedure, including looking up the login credentials in a database table storing user credentials. Login to the application is denied at S315 if the authentication is not successful. If authentication is successful, flow proceeds to S320 to receive a request for a blockchain transaction.

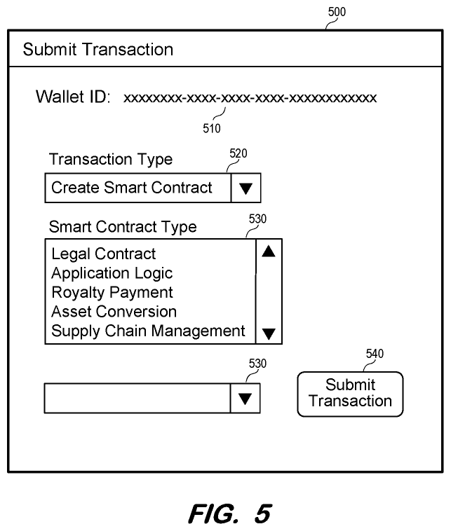

The user may submit the request in any suitable manner that is or becomes known. Moreover, the transaction may consist of any type of blockchain transaction that is or becomes known. FIG. 5 illustrates interface 500 of a Web2 application to submit the request according to some embodiments.

Field 510 of interface 500 specifies an identifier of the wallet with which the requested transaction is to be associated. The requested transaction is to be signed by the private key which is associated with the identifier and is to be represented on the blockchain by the identifier. Interface 500 provides drop-down menu 520 which allows the user to specify a transaction type. Since the transaction type “Create Smart Contract” is selected, input area 530 displays a list of selectable smart contracts. Once a smart contract (i.e., a transaction) is selected, the user may select control 540 to request transmission of the transaction to the blockchain.

At S325, it is determined whether the user is authorized to perform the requested transaction. In this regard, the Web2 application may store data indicating, for each user of each tenant, certain blockchain transactions which the user is authorized to perform (and/or transactions which the user is not authorized to perform). Authorizations may be role-based according to some embodiments as is known in the art.

The transaction is denied at S330 if it is determined to be unauthorized at S325. If the transaction is authorized, a wallet identifier is determined at S335. The wallet identifier may be associated with the tenant of the user and stored by the Web2 application during creation of a corresponding keypair as described above.

At S340, the requested transaction is generated and signed using the determined wallet identifier. In the present example, the transaction may comprise an interaction with a factory smart contract corresponding to the selected smart contract that causes cloning of the factory smart contract. In some embodiments of S340, a HyperText Transfer Protocol (HTTP) RPC call is generated specifying the transaction and a request is transmitted to a key vault to sign the transaction using the private key associated with the wallet identifier. The key vault signs the transaction with the private key and returns the signed transaction for receipt at S345. The signed transaction is then transmitted to the blockchain at S350 using, for example, a JSON RPC call which corresponds to the HTTP RPC call.

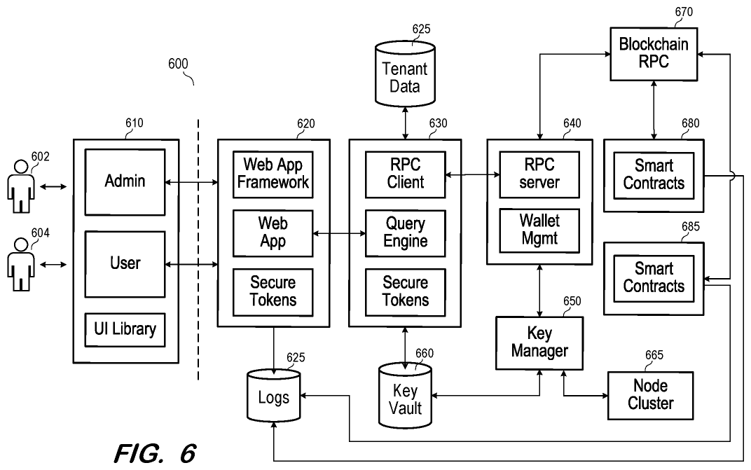

FIG. 6 is a detailed block diagram of system 600. System 600 may comprise one implementation of system 100 according to some embodiments. System 600 includes client 610 which executes within a user device, client server 620, API layer 630 and Web3 interface 640. In some embodiments, client server 620, API layer 630 and Web3 interface 640 are deployed as Docker containers using Kubernetes. Client server 620, API layer 630 and Web3 interface 640, as well as key manager 650, may be deployed in a same on-premise backend.

Client 610 may comprise a single page application using a UI library such as React, for example. The single page application may support an administrator experience for administrator 602 and a user experience for user 604. Client 610 may be served by a Web application of client server 620 built on a Web application framework such as Next.js. The Web application of client server 620 or the single page application of client 610 may communicate with API layer 630 via an API query language such as GraphQL and leverages secure tokens (e.g., Web tokens) for user authentication, user authorization, and multi-tenancy.

API layer 630 supports client experiences with a traditional Web2 data source, while also passing through and staying in sync with Web3 data through the Web3 interface 640. API layer 630 may comprise a traditional Software-as-a-Service application providing user and account management, Web2 data models and data storage, and multitenancy support. API layer 630 allows access through the secure tokens (e.g., PASETO tokens, JSON Web Tokens), saves transactional data into tenant data 625, and runs an RPC (e.g., gRPC) client to communicate with Web3 interface 640. The secure tokens store information regarding the user, the tenant, and the users role. All queries use the token information, and not API arguments, for authentication and authorization.

Web3 interface 640 is a stateless service that handles interactions with blockchains 680 and 685. For example, Web3 interface 640 may transmit signed transactions to blockchains 680 and 685. The transactions may, for example, create an asset, transfer an asset, create a smart contract, or interact with a smart contract. In the latter regard, Web3 interface 640 should provide transactions needed to execute the functionality of the created smart contracts so that API layer 630 can call that functionality via Web3 interface 640.

Embodiments are not limited to two blockchains. Web3 interface 640 may communicate with blockchains 680 and 685 via blockchain RPC 670. Blockchain RPC 670 may be provided by a 3rd party (e.g., Alchemy) but embodiments are not limited thereto. Web3 interface 640 may comprise a Rust server which communicates with API layer 630 through gRPC, where Protocol Buffers define the API contracts between Web3 interface 640 and API layer 630.

Web3 interface 640 provides management of tenant (i.e., custodial) and user wallets. Wallet management includes wallet creation, funds transfer, and other functionalities. Wallet management also includes orchestration of blockchain transaction signing using a private key associated with a wallet. Web3 interface 640 communicates with key manager 650 to perform such signing. Key manager 650 may comprise a trusted open-source key management solution such as Consensys Quorum Key Manager but embodiments are not limited thereto.

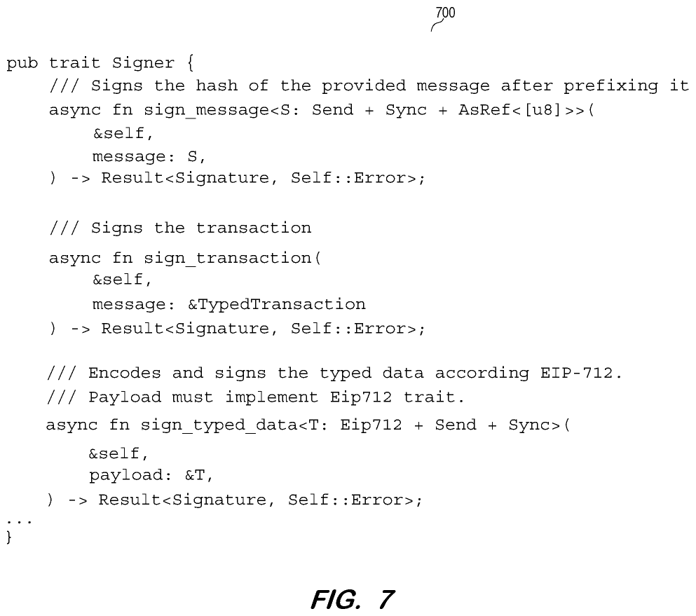

Key manager 650 may implement a remote signing utility which is called by Web3 interface 640 to request signing of a transaction. FIG. 7 is an example of code 700 of a remote signing utility of key manager 650 using the ethers-signer trait according to some embodiments. Key manager 650 may in turn request signing of a transaction using a private key stored in key vault 660 or in node cluster 665. Node cluster 665 may store private key shards across nodes in a redundant manner as is known in the art.

A clone factory contract (e.g., EIP-1167) for each smart contract to be used may be deployed on blockchains 680 and 685. A clone factory contract is called by Web3 interface 640 to clone new smart contracts on its blockchain. The clone factory contracts may leverage open-source libraries (e.g., OpenZeppelin) and may comprise Solidity smart contracts in the cash of the Ethereum blockchain.

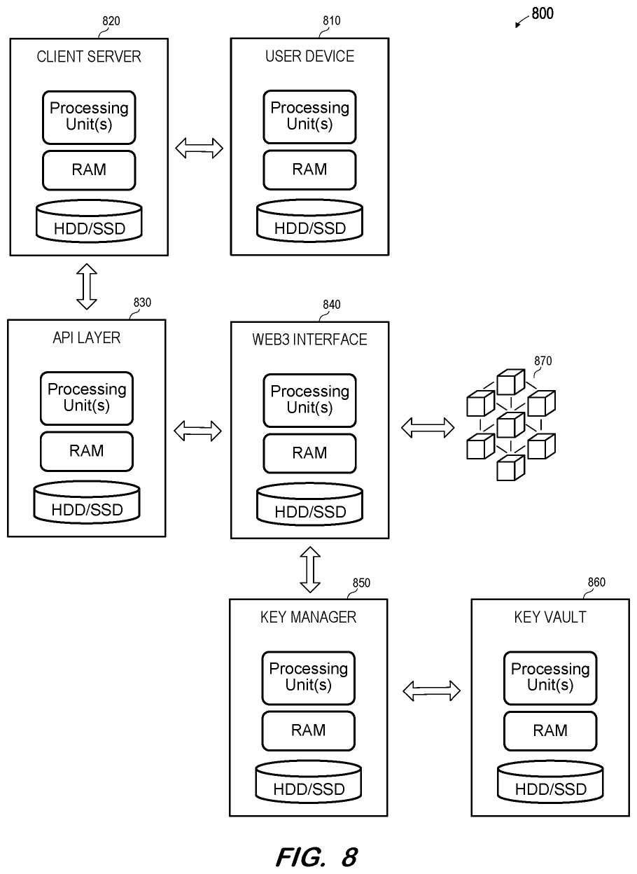

FIG. 8 is a block diagram of cloud-based architecture 800 according to some embodiments. Client server 820, API layer 830, Web3 interface 840, and key manager 850 may comprise cloud-based compute resources, such as one or more virtual machines, allocated by a public cloud provider providing self-service and immediate provisioning, autoscaling, security, compliance and identity management features. Client server 820, API layer 830, Web3 interface 840, and key manager 850 may execute containerized applications deployed in Docker containers on Kubernetes. A user may operate user device 810 to interact with client server via a Web2 paradigm. The remaining components of architecture 800, including key vault 860, may operate as described above to transmit transactions to blockchain 870 in response to the interactions

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing executable program code; and
at least one processing unit to execute the program code to cause the system to:
receive credentials of a user at a Web server;
authenticate the user based on the credentials;
receive a request from the user to transmit an operation to a Web3 database; and
in response to the received request:
query a Web2 database for an identifier associated with the user;
request encryption of the operation by a private key associated with the identifier;
receive an encrypted operation in response to the requested encryption of the operation; and
transmit the encrypted operation to the Web3 database.

2. The system of claim 1, the at least one processing unit to execute the program code to cause the system to:
determine whether the user is authorized to transmit the operation to the Web3 database.

3. The system of claim 1, wherein transmission of the encrypted operation to the Web3 database comprises:
determination of a JavaScript Object Notation Remote Procedure Call corresponding to the operation; and
execution of the JavaScript Object Notation Remote Procedure Call to transmit the encrypted operation to the Web3 database.

4. The system of claim 3, wherein the received request to transmit the operation to the Web3 database comprises a Hypertext Transfer Protocol Remote Procedure Call.

5. The system of claim 1, wherein requesting encryption of the operation by the private key associated with the identifier comprises:
transmission of the operation and the identifier to a key manager; and
execution of the key manager to:
retrieve a stored primary key identifier associated with the identifier; and
transmit the primary key identifier and the operation to a key vault.

6. The system of claim 1, the at least one processing unit to execute the program code to cause the system to:
receive second credentials of a second user at the Web server;
authenticate the second user based on the second credentials;
receive a second request from the second user to transmit a second operation to a second Web3 database; and
in response to the received second request:
query the Web2 database for a second identifier associated with the second user;
request encryption of the second operation by a second private key associated with the second identifier;
receive a second encrypted operation in response to the requested encryption of the second operation; and
transmit the second encrypted operation to the second Web3 database.

7. The system of claim 1, the at least one processing unit to execute the program code to cause the system to:
receive second credentials of a second user at the Web server;
authenticate the second user based on the second credentials;
receive a second request from the second user to transmit a second operation to a second Web3 database; and
in response to the received second request:
request encryption of the second operation by the private key associated with the identifier;
receive a second encrypted operation in response to the requested encryption of the second operation; and
transmit the second encrypted operation to the second Web3 database.

8. A method comprising:
receiving credentials of a user at a Web server;
generating a token comprising an identifier of the user;
receiving a request from the user to transmit an operation to a Web3 database, the request including the token; and
in response to the received request:
querying a database for an identifier associated with the user;
requesting encryption of the operation by a private key associated with the identifier;
receiving an encrypted operation in response to the requested encryption of the operation; and
transmitting the encrypted operation to the Web3 database.

9. The method of claim 8, further comprising:
determining whether the user is authorized to transmit the operation to the Web3 database.

10. The method of claim 8, wherein transmitting the encrypted operation to the Web3 database comprises:
determining a JavaScript Object Notation Remote Procedure Call corresponding to the operation; and
executing the JavaScript Object Notation Remote Procedure Call to transmit the encrypted operation to the Web3 database.

11. The method of claim 10, wherein the received request to transmit the operation to the Web3 database comprises a Hypertext Transfer Protocol Remote Procedure Call.

12. The method of claim 8, wherein requesting encryption of the operation by the private key associated with the identifier comprises:
transmitting the operation and the identifier to a key manager; and
executing the key manager to:
retrieve a stored primary key identifier associated with the identifier; and
transmit the primary key identifier and the operation to a key vault.

13. The method of claim 8, further comprising:
receiving second of a second user at the Web server;
generating a second token comprising a second identifier of the second user;
receiving a second request from the second user to transmit a second operation to a second Web3 database, the second request comprising the second token; and
in response to the received second request:
querying the database for a second identifier associated with the second user;
requesting encryption of the second operation by a second private key associated with the second identifier;
receiving a second encrypted operation in response to the requested encryption of the second operation; and
transmitting the second encrypted operation to the second Web3 database.

14. The method of claim 8, further comprising:
receiving second of a second user at the Web server;
generating a second token comprising a second identifier of the second user;
receiving a second request from the second user to transmit a second operation to a second Web3 database, the second request comprising the second token; and
in response to the received second request:
requesting encryption of the second operation by the private key associated with the identifier;
receiving a second encrypted operation in response to the requested encryption of the second operation; and
transmitting the second encrypted operation to the second Web3 database.

15. A non-transitory medium storing program code executable by at least one processing unit of a computing system to cause the computing system to:
receive credentials of a user at a Web server;
authenticate the user based on the credentials;
receive a request from the user to transmit an operation to a Web3 database; and
in response to the received request:
query a database for an identifier associated with the user;
request encryption of the operation by a private key associated with the identifier;
receive an encrypted operation in response to the requested encryption of the operation; and
transmit the encrypted operation to the Web3 database.

16. The medium of claim 15, the at least one processing unit to execute the program code to cause the system to:
determine whether the user is authorized to transmit the operation to the Web3 database.

17. The medium of claim 15, wherein transmission of the encrypted operation to the Web3 database comprises:
determination of a JavaScript Object Notation Remote Procedure Call corresponding to the operation; and
execution of the JavaScript Object Notation Remote Procedure Call to transmit the encrypted operation to the Web3 database.

18. The medium of claim 17, wherein the received request to transmit the operation to the Web3 database comprises a Hypertext Transfer Protocol Remote Procedure Call.

19. The medium of claim 15, wherein requesting encryption of the operation by the private key associated with the identifier comprises:
transmission of the operation and the identifier to a key manager; and
execution of the key manager to:
retrieve a stored primary key identifier associated with the identifier; and
transmit the primary key identifier and the operation to a key vault.

20. The medium of claim 15, the at least one processing unit to execute the program code to cause the system to:
receive second credentials of a second user at the Web server;
authenticate the second user based on the second credentials;
receive a second request from the second user to transmit a second operation to a second Web3 database; and
in response to the received second request:
request encryption of the second operation by the private key associated with the identifier;
receive a second encrypted operation in response to the requested encryption of the second operation; and
transmit the second encrypted operation to the second Web3 database.
